(19) United States
(12) Patent Application Publication
(10) Pub. No.: US 2024/0235989 A1
(43) Pub. Date: Jul. 11, 2024

(54) SWITCH PORT AGGREGATION IN CENTRALIZED SOFTWARE-DEFINED NETWORKS (SDN)

(71) Applicant: Mellanox Technologies, Ltd., Yokneam (IL)

(72) Inventors: Ayal LIOR, Modiin (IL); Ortal BASHAN, Tel Aviv (IL); Guy Rozenberg KUNIEVSKY, Rehovut (IL); Alex NETES, Rehovot (IL)

(73) Assignee: Mellanox Technologies, Ltd., Yokneam (IL)

(21) Appl. No.: 18/093,478

(22) Filed: Jan. 5, 2023

(51) Int. Cl. H04L 45/24; H04L 49/60

(52) U.S. Cl. CPC H04L 45/245; H04L 49/60

(57) ABSTRACT

Systems and methods are described herein for aggregating ports in a centralized software-defined network (SDN) environment. An example system receives data transfer requirements associated with data communication to a second device; generates an aggregated switching model based on at least the data transfer requirements; and configures, using an SDN controller, an aggregated port to facilitate the transfer of data to the second device based on the aggregated switching model. The aggregated port includes one or more data lanes adapted to handle data traffic; one or more ports operatively coupled to the one or more data lanes, wherein the one or more ports are aggregated using an aggregated switching model; and a unitary interface operatively coupled to the one or more ports and adapted for external connection.

### TECHNOLOGICAL FIELD

Example embodiments of the present disclosure relate to data communications and, more particularly, to data communications using aggregated ports in centralized Software-Defined Networks (SDN).

### BACKGROUND

As High Performance Computing (HPC) systems continue to increase in size, addressing issues with performance, scalability, cost, and resilience poses a major challenge for HPC interconnect technologies.

Applicant has identified a number of deficiencies and problems associated with hardware configuration in HPC interconnect systems. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for switch port aggregation in centralized Software-Defined Networks (SDN).

In one aspect, an aggregated port is presented. The aggregated port comprises one or more data lanes adapted to handle data traffic; one or more ports operatively coupled to the one or more data lanes, wherein the one or more ports are aggregated using an aggregated switching model; and a unitary interface operatively coupled to the one or more ports and adapted for external connection.

In some embodiments, the aggregated switching model defines an aggregation topology associated with the aggregation of the one or more ports, wherein the aggregated switching model comprises logical parameters and physical parameters.

In some embodiments, the aggregated port is configured to be operatively coupled to a first device via the unitary interface.

In some embodiments, when the aggregated port is operatively coupled to the first device, only the unitary interface is visible to a user, and the one or more ports and the one or more data lanes are obscured from the user.

In some embodiments, the first device is a host device.

In some embodiments, the one or more ports are operatively coupled to one or more data lanes such that each port is operatively coupled to a corresponding data lane.

In some embodiments, the one or more ports are operatively coupled to one or more data lanes such that each port is operatively coupled to two or more data lanes.

In some embodiments, the one or more ports operate independently of one another.

In another aspect, a system for aggregating ports in a centralized software defined network (SDN) environment is presented. The system comprises a first device and a port aggregation module operatively coupled to the first device. The port aggregation module is to receive data transfer requirements associated with data communication to a second device; generate an aggregated switching model based on at least the data transfer requirements; and configure, using an SDN controller, an aggregated port to facilitate the transfer of data to the second device based on the aggregated switching model.

In some embodiments, the one or more data transfer requirements comprises at least a bandwidth requirement.

In yet another aspect, a method for aggregating ports in a centralized software defined network (SDN) environment is presented. The method comprises receiving data transfer requirements associated with data communication to a second device; generating an aggregated switching model based on at least the data transfer requirements; and configuring, using an SDN controller, an aggregated port to facilitate the transfer of data to the second device based on the aggregated switching model.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIG. 1A illustrates an example network environment for aggregating ports in a centralized software-defined network (SDN) environment, in accordance with an embodiment of the present disclosure;

FIG. 1B illustrates an example block diagram of a system for use with various embodiments of the present disclosure; and

FIG. 2 illustrates an example method for aggregating ports in a centralized SDN environment, in accordance with an embodiment of the present disclosure.

### DETAILED DESCRIPTION

### Overview

As High Performance Computing (HPC) systems continue to increase in size, addressing issues with performance, scalability, cost, and resilience poses a major challenge for HPC interconnect technologies. Software-Defined Networks (SDN) promise a whole new range of network flexibility and scalability by having a centralized coherent view of the network, the topology, and data traffic demands. Scaling in a network switch fabric typically begins at the lowest resolution, i.e., single lane data ports (e.g., lx Serializer/Deserializer link running at 200 Gbps). Thus, a conventional network can be scaled up if additional data lanes are introduced, resulting in additional ports for the data lanes. While scaling is achievable, the physical entities, such as cables, transceivers, ports, and/or the like, in a switch do not change. This creates a hardware configuration and realization issue for any device having a number of ports and data lanes as additional data lanes and ports are introduced.

Embodiments of the present invention address this problem by introducing a system and method for aggregating ports in a centralized SDN network environment. The aggregated port described herein may include a number of independent ports that are bundled to work together to handle data traffic. To this end, each port may be operatively coupled to one or more data lanes that are adapted to handle data traffic. According to embodiments of the disclosure, the aggregated port may include a unitary interface that is adapted for external connection to a device. Any time a user connects the aggregated port to a device, only the unitary interface is visible to the user. The independent ports and the associated data lanes are obscured from their view. In other words, according to embodiments of the present invention, the user is oblivious to the internal functions of the aggregated port. For example, if the data transfer requirements include a bandwidth requirement of 1600 Gbps, embodiments of the present invention may identify 8 ports with 200 Gbps capacity and aggregate them such that their functionality in a bundle meets the 1600 Gbps requirement. The user is unaware of this aggregation. What is more, each port in the 8-port bundle continues to function independently of the other ports, i.e., each port continues to transmit 200 Gbps, in that the ports are also unaware of being part of the functionality of the 8-port bundle. According to such embodiments, the aggregated port may be configured using a device (e.g., a first device). To this end, a port aggregation module associated with the device may identify application-specific data transfer requirements and generate an aggregated switching model defining an aggregation topology for port aggregation. The aggregated port may then be configured in such a way that any data communication that is generated by the application is transmitted from the device via the aggregated port according to the aggregated switching model.

Embodiments of the present invention will now be described more fully hereinafter with reference to the accompanying drawings, in which some, but not all, embodiments are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically coupled and/or are in or are capable of electrical communication with one another, or optically coupled and/or are in or are capable of optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example Port Aggregation Systems

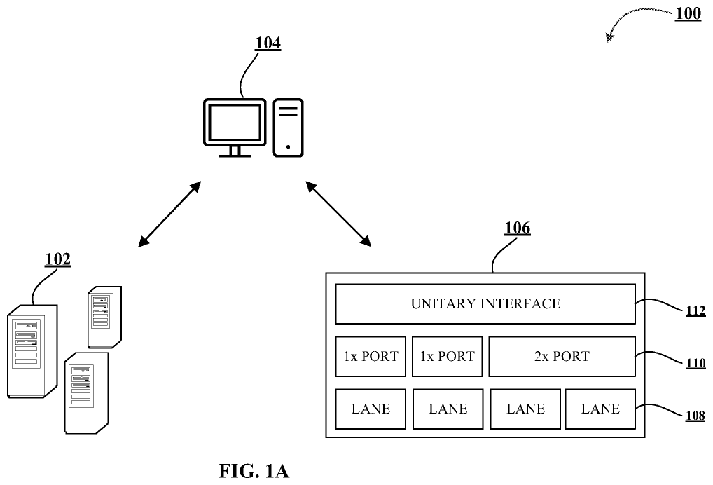

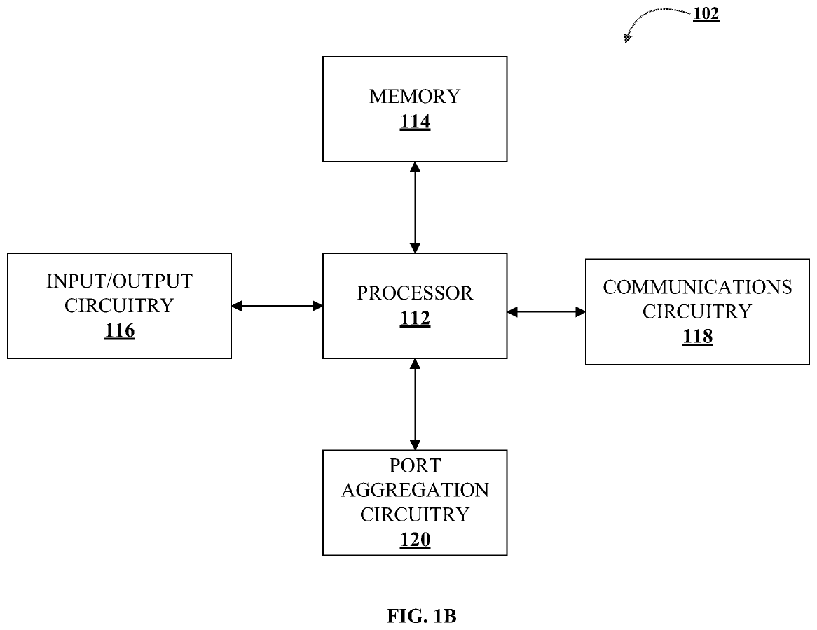

FIG. 1A illustrates an example network environment for aggregating ports in a centralized software-defined network (SDN) environment 100, in accordance with an embodiment of the present disclosure. As shown in FIG. 1A, the network environment 100 may include a system 102, a first device 104, and an aggregated port 106. It is to be understood that the structure of the network environment 100 and its components, connections and relationships, and their functions, are meant to be examples, only, and are not meant to limit implementations of the embodiments described and/or claimed in this document. In one example, the network environment 100 may include more, fewer, or different components. In another example, some or all of the portions of the network environment 100 may be combined into a single portion, or all of the portions of the network environment 100 may be separated into two or more distinct portions.

The system 102 may be implemented in a number of different forms. In one example, the system 102 may be implemented as a standard server, where the system 102 may be a Network Interface Card (NIC) of the standard server. In another example, the system 102 may be implemented multiple times in a group of such servers, where the system 102 may be multiple NICs associated with various servers. Additionally, the system 102 may also be implemented as part of a rack server system or a personal computer such as a laptop computer. Alternatively, components from the system 102 may be combined with one or more other same or similar systems and an entire system 102 may be made up of multiple computing devices communicating with each other. The system 102 may represent various forms of servers, such as web servers, database servers, file server, or the like, various forms of digital computing devices, such as laptops, desktops, workstations, or the like, or any other auxiliary network devices, Internet-of-things devices, electronic kiosk devices, mainframes, or the like, or any combination of the aforementioned. In some examples, the system 102 may include, in whole or in part, the first device 104 and/or the first device 104 may include, in whole or in part, the system 102. The system 102 is described in greater detail below in connection with FIG. 1B.

With continued reference to FIG. 1A, the first device 104 may refer to any network device (e.g., a host device) that is capable of sending and receiving data over a network. The first device 104 may include hardware components (e.g., a server, client, peer, transmission medium, connecting device, and/or the like) and/or software components (e.g., Operating Systems (OS) installed thereon to facilitate network interactions, network protocol suites defining a set of related protocols for data communication within a computing environment, and/or the like) capable of being configured for data communication. The first device 104 may be associated with a switch fabric topology in which the various nodes may be interconnected via a number of switches (e.g., crossbar switches). In some example embodiments, the first device may be associated with a High Performance Computing (HPC) cluster that uses HPC interconnect communications standard (e.g., Infiniband® networking technology) for data communication therebetween. The first device 104 may represent various forms of network devices such as routers, switches, hubs, access points, and/or the like, servers, such as web servers, database servers, file servers, and/or the like, and/or edge devices such as routers, routing switches, integrated access devices (IAD), and/or the like.

The aggregated port 106 may refer to a port cluster that includes a plurality of ports configured as either physical or virtual connection points. In one aspect, the aggregated port 106 port may be a connector that is used to connect the first device 104 to the network. Accordingly, the aggregated port 106 may be a physical interface that allows the first device 104 to transmit and receive data over a network. In another aspect, the aggregated port 106 may be a virtual connection point that may refer to an application-specific or process-specific software construct serving as a communications endpoint in the operating system of the first device 104. As described in further detail herein, the aggregated port 106 may be configured and managed by the Software Defined Network (SDN) controller during data communication, and exposed to other devices in the network therethrough. Accordingly, the aggregated port 106 may uniquely identify different applications or processes running on the first device and enable them to share a physical connection to a network.

As shown in FIG. 1A, the aggregated port 106 may include a data lane layer 108, a port layer 110, and a unitary interface 112. The data lane layer 108 may include one or more data lanes. Each data lane may include a Serializer/Deserializer (SerDes) that is used in high speed communications to handle data traffic and provide data transmission over a single line or a differential pair. Such data lanes are typically implemented in HPC clusters executing applications that require high speed data communication and distributed data processing with minimal number of input/output interconnects. As such, data lanes may be a fundamental building block of a physical layer for HPC interconnect clusters.

The port layer 110 may include one or more ports. The ports in the port layer 110 may be operatively coupled to the data lanes in the data lane layer 108. To this end, in some embodiments, each port may be operatively coupled to a corresponding data lane such that data traffic handled by the data lane terminates at a corresponding port for point of entry communication with the first device 104. In some other embodiments, each port may be operatively coupled to two or more data lanes such that the combined data traffic handled by the two or more data lanes terminates at the corresponding port for point of entry communication with the first device 104. While individual ports and data lanes provide high speed data communication within HPC clusters as interconnects, computationally-intensive applications, such as artificial intelligence (AI), automotive, mobile, and Internet-of-Things (IoT) applications, often have specific requirements (e.g., data speed, bandwidth, latency, and/or the like) beyond the capacity of individual ports and data lanes. In such cases, a subset of ports in the port layer 110 may be bundled to work together to handle data traffic that meets the application-specific requirements. In embodiments described herein, the subset of ports may be bundled based on an aggregated switching model that includes logical and physical parameters defining an aggregation topology based on application-specific requirements.

The aggregated port 106 may further include a unitary interface 112 that is operatively coupled to the ports in the port layer 110. The unitary interface 112 is adapted for external connection to an external device (e.g., the first device 104). In embodiments described herein, when a user is attempting to operatively couple the aggregated port 106 to the first device 104, only the unitary interface 112 is visible to the user. The ports in the port layer 110 and the various data lanes in the data lane layer 108 housed in such a way that the individual ports and the data lanes are obscured from the user. What is more, the user is unaware of the aggregated switching model, the specific subset of ports that are bundled based on the aggregated switching model, and the application-specific requirements used to generate the aggregated switching model for data communication. The user physically only sees the unitary interface 112 and remains unaware of the underlying functionality of the aggregated port 106.

### Example System Circuitry

FIG. 1B illustrates an example block diagram of a system 102 for use with various embodiments of the present disclosure. As shown in FIG. 1B, the system 102 may include a processor 112, a memory 114, input/output circuitry 116, communications circuitry 118, and port aggregation circuitry 120. As described herein, in some examples, the system 102 may include, in whole or in part, the first device 104 and/or the first device 104 may include, in whole or in part, the system 102.

Although the term “circuitry” as used herein with respect to components 112-120 is described in some cases using functional language, it should be understood that the particular implementations necessarily include the use of particular hardware configured to perform the functions associated with the respective circuitry as described herein. It should also be understood that certain of these components 112-120 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the system 102 may be housed within this device, while other components are housed within other devices (e.g., a controller in communication with the system 102).

While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the system 102 may provide or supplement the functionality of particular circuitry. For example, the processor 112 may provide processing functionality, the memory 114 may provide storage functionality, the communications circuitry 118 may provide network interface functionality, and the like.

In some embodiments, the processor 112 (and/or co-processor or any other processing circuitry assisting or otherwise associated with the processor) may be in communication with the memory 114 via a bus for passing information among components of, for example, the system 102. The memory 114 may be non-transitory and may include, for example, one or more volatile and/or non-volatile memories, or some combination thereof. In other words, for example, the memory 114 may be an electronic storage device (e.g., a non-transitory computer readable storage medium). The memory 114 may be configured to store information, data, content, applications, instructions, or the like, for enabling an apparatus, e.g., the system 102, to carry out various functions in accordance with example embodiments of the present disclosure.

Although illustrated in FIG. 1B as a single memory, the memory 114 may comprise a plurality of memory components. The plurality of memory components may be embodied on a single computing device or distributed across a plurality of computing devices. In various embodiments, the memory 114 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 114 may be configured to store information, data, applications, instructions, or the like for enabling the system 102 to carry out various functions in accordance with example embodiments discussed herein. For example, in at least some embodiments, the memory 114 is configured to buffer data for processing by the processor 112. Additionally, or alternatively, in at least some embodiments, the memory 114 is configured to store program instructions for execution by the processor 112. The memory 114 may store information in the form of static and/or dynamic information. This stored information may be stored and/or used by the system 102 during the course of performing its functionalities.

The processor 112 may be embodied in a number of different ways and may, for example, include one or more processing devices configured to perform independently. Additionally, or alternatively, the processor 112 may include one or more processors configured in tandem via a bus to enable independent execution of instructions, pipelining, and/or multithreading. The processor 112 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 1B as a single processor, in some embodiments, the processor 112 may include a plurality of processors. The plurality of processors may be embodied on a single computing device or may be distributed across a plurality of such devices collectively configured to function as the system 102. The plurality of processors may be in operative communication with each other and may be collectively configured to perform one or more functionalities of the system 102 as described herein.

In an example embodiment, the processor 112 is configured to execute instructions stored in the memory 114 or otherwise accessible to the processor 112. Alternatively, or additionally, the processor 112 may be configured to execute hard-coded functionality. As such, whether configured by hardware or software methods, or by a combination thereof, the processor 112 may represent an entity (e.g., physically embodied in circuitry) capable of performing operations according to an embodiment of the present disclosure while configured accordingly. Alternatively, as another example, when the processor 112 is embodied as an executor of software instructions, the instructions may specifically configure the processor 112 to perform one or more algorithms and/or operations described herein when the instructions are executed. For example, these instructions, when executed by the processor 112, may cause the system 102 to perform one or more of the functionalities thereof as described herein.

In some embodiments, the system 102 further includes input/output circuitry 116 that may, in turn, be in communication with the processor 112 to provide an audible, visual, mechanical, or other output and/or, in some embodiments, to receive an indication of an input from a user or another source. In that sense, the input/output circuitry 116 may include means for performing analog-to-digital and/or digital-to-analog data conversions. The input/output circuitry 116 may include support, for example, for a display, touchscreen, keyboard, mouse, image capturing device (e.g., a camera), microphone, and/or other input/output mechanisms. The input/output circuitry 116 may include a user interface and may include a web user interface, a mobile application, a kiosk, or the like.

The processor 112 and/or user interface circuitry comprising the processor 112 may be configured to control one or more functions of a display or one or more user interface elements through computer-program instructions (e.g., software and/or firmware) stored on a memory accessible to the processor 112 (e.g., the memory 114, and/or the like). In some embodiments, aspects of the input/output circuitry 116 may be reduced as compared to embodiments where the system 102 may be implemented as an end-user machine or other type of device designed for complex user interactions. In some embodiments (like other components discussed herein), the input/output circuitry 116 may be eliminated from the system 102. The input/output circuitry 116 may be in communication with the memory 114, communications circuitry 118, and/or any other component(s), such as via a bus. Although more than one input/output circuitry and/or other component can be included in the system 102, only one is shown in FIG. 1B to avoid overcomplicating the disclosure for ease of explanation (e.g., as with the other components discussed herein).

The communications circuitry 118, in some embodiments, includes any means, such as a device or circuitry embodied in either hardware, software, firmware or a combination of hardware, software, and/or firmware, that is configured to receive and/or transmit data from/to a network and/or any other device, circuitry, or module in communication with the first device. In this regard, the communications circuitry 118 may include, for example, a network interface for enabling communications with a wired or wireless communication network. For example, in some embodiments, communications circuitry 118 may be configured to receive and/or transmit any data that may be stored by the memory 114 using any protocol that may be used for communications between computing devices. For example, the communications circuitry 118 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 118 may include circuitry for interacting with antenna(e) to cause transmission of signals via the antenna(e) or to handle receipt of signals received via the antenna(e). These signals may be transmitted by the system 102 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 118 may additionally or alternatively be in communication with the memory 114, the input/output circuitry 116, and/or any other component of system 102, such as via a bus. The communication circuitry 118 of the system 102 may also be configured to receive and transmit information with the various network ports discussed herein.

The port aggregation circuitry 120, in some embodiments, captures application-specific data transfer requirements from applications stored in the memory 114. The application-specific data transfer requirements may refer to conditional requirements for the application to transmit and receive data. These conditions may include bandwidth requirement, availability and reliability of the network connection, port redundancy requirements, security and privacy requirements, and/or the like. As part of the aggregated switching model, the port aggregation circuitry 120 may define an aggregation topology that is used to configure the aggregated port. The port aggregation circuitry 120 may include an SDN controller that is used to configure and subsequently manage the aggregated port and any data transfer associated therewith.

In some embodiments, the system 102 includes hardware, software, firmware, and/or a combination of such components, configured to support various aspects of port aggregation. It should be appreciated that in some embodiments, the port aggregation circuitry 120 may perform one or more of such example actions in combination with another circuitry of the system 102, such as the memory 114, processor 112, input/output circuitry 116, and communications circuitry 118. For example, in some embodiments, the port aggregation circuitry 120 utilizes processing circuitry, such as the processor 112 and/or the like, to form a self-contained subsystem to perform one or more of its corresponding operations. In a further example, and in some embodiments, some or all of the functionality of the port aggregation circuitry 120 may be performed by processor 112. In this regard, some or all of the example processes and algorithms discussed herein can be performed by at least one of the processor 112 or the port aggregation circuitry 120. It should also be appreciated that, in some embodiments, the port aggregation circuitry 120 may include a separate processor, specially configured field programmable gate array (FPGA), or application specific interface circuit (ASIC) to perform its corresponding functions.

Additionally, or alternatively, in some embodiments, the port aggregation circuitry 120 may use the memory 114 to store collected information. For example, in some implementations, the port aggregation circuitry 120 includes hardware, software, firmware, and/or a combination thereof, that interacts with the memory 114 to send, retrieve, update, and/or store data.

Accordingly, non-transitory computer readable storage media can be configured to store firmware, one or more application programs, and/or other software, which includes instructions and/or other computer-readable program code portions that can be executed to direct operation of the system 102 to implement various operations, including the examples shown herein. As such, a series of computer-readable program code portions may be embodied in one or more computer-program products and can be used, with a device, system 102, database, and/or other programmable apparatus, to produce the machine-implemented processes discussed herein. It is also noted that all or some of the information discussed herein can be based on data that is received, generated and/or maintained by one or more components of the system 102. In some embodiments, one or more external systems (such as a remote cloud computing and/or data storage system) may also be leveraged to provide at least some of the functionality discussed herein.

### Example Methods for Aggregating Ports in a Centralized Software-Defined Network (SDN)Environment

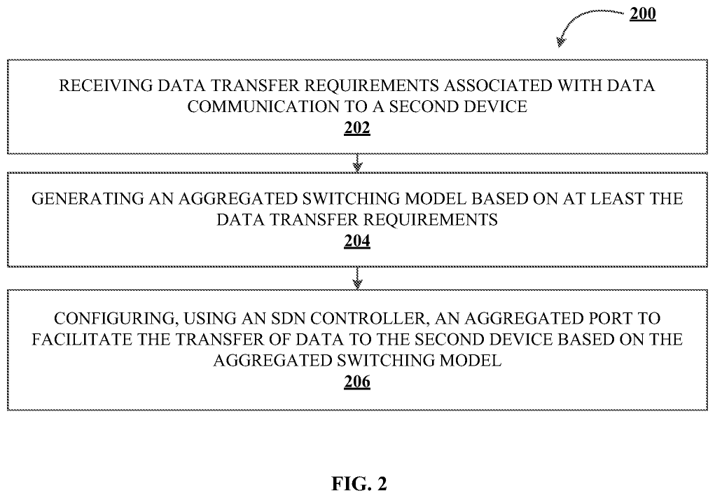

FIG. 2 illustrates an example method for aggregating ports in a centralized SDN environment, in accordance with an embodiment of the present disclosure. As shown in block 202, the method according to some embodiments includes receiving data transfer requirements associated with data communication to a second device. The second device, similar to the first device, may refer to any network device (e.g., a spine switch) that is capable of sending and receiving data over a network. In some embodiments, the system may receive the data transfer requirements from one or more applications installed on the first device. In one aspect, the data transfer requirements may be application-specific requirements defined by one or more applications associated with the first device. As described herein, the first device may include an aggregated port operatively coupled therewith and configured to facilitate data communication between the first device and the second device. The aggregated port may include a plurality of ports that allows the first device to transmit and receive data communication.

In some embodiments, as shown in block 204, the method includes generating an aggregated switching model based on at least the data transfer requirements. The aggregated switching model may be used to configure specific ports in the aggregated port to ensure that the data transfer requirements are met for data communication between the first device and the second device. In this regard, the aggregated switching model may define an aggregation topology for the ports in the aggregated port to be bundled during operation. The aggregated switching model may include logical parameters and/or physical parameters that may be used to configure the state of each port. For example, the logical parameters and/or the physical parameters may be used to define whether a particular port is in a sleep state, a polling state, a linkup state, a down state, an initial state, an armed state, an active state, and/or a disabled state. As described herein, while the aggregated switching model is used to manage overall data communication using the aggregated port, it attaches specific rules to individual ports rather than the port bundle as a whole.

In some embodiments, depending on the data transfer requirements, the system may determine specific ports to be bundled for aggregation. In one aspect, the system may bundle all the available ports in the aggregated port for data communication. In another aspect, the system may bundle a subset of ports in the aggregated port for data communication. In some cases, during data communication, the ports that are not included in the bundle may remain dormant while the bundled subset of ports is involved in the data communication. In some other cases, during data communication, the ports that are not included in the bundle may be configured as redundant ports and may be put on stand-by in case one or more of the ports in the subset of ports malfunction during data communication.

Next, as shown in block 206, the method includes configuring, using an SDN controller, the aggregated port that is connected to the first device, to facilitate the transfer of data to the second device based on the aggregated switching model. As described herein, by configuring the aggregated port using the aggregated switching model, the system may ensure that the data transfer requirements are met. To this end, the system may employ an SDN controller. An SDN controller is a central component of an SDN architecture that provides a centralized view of the network and makes decisions about how data communication is structured. SDN architecture refers to a networking approach that enables the separation of the control plane, which determines how data is transmitted through a network, from the data plane, which forwards the data based on the instructions from the control plane. Accordingly, the SDN controller may not only configure the aggregated port, but also manage the aggregated port during data communication. In addition, the SDN controller may subject the aggregated port to and subsequently execute mitigation actions in an instance where one of the ports in the subset of ports malfunction. Furthermore, the SDN controller may perform the requisite counting and maintenance on the aggregated port as a whole or individual ports in the aggregation.

In some embodiments, the first device may be a host device where the traffic flow originates. The application generating the data may be configured to identify the aggregated port connected to the host device and transmit data towards the port. The host device may then determine the specific subset of ports that are bundled according to the aggregated switching model generated specifically for that application. Once the subset of ports is identified, the host device may then use the subset of ports to transmit data to the second device. In subsequent devices (e.g., switches), the data is forwarded in a similar manner. As such, the application generating the data is bound to the aggregated port in both transmission and reception of data traffic associated with the data communication. While the subset of ports is bundled to handle data communications, each port in the subset of ports is unaware of its participation in the bundle and operates independently to transmit and receive data. For example, if the data transfer requirements include a bandwidth requirement of 800 Gbps, the aggregated switching model may identify 8 ports with 100 Gbps capacity and aggregate them such that their functionality in a bundle meets the 800 Gbps requirement. Each port in the 8-port bundle continues to function independently of the other ports, i.e., each port continues to transmit 100 Gbps, in that the ports remain unaware of being part of the functionality of the 8-port bundle. The first device (and any corresponding application associated with the data transfer requirements), however, is aware of the aggregation and structures the data communication accordingly. As such, the aggregated switching model attaches specific rules to individual ports rather than the subset of ports as a whole. The selection of these ports may be controlled locally or using the SDN controller.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An aggregated port comprising:
one or more data lanes adapted to handle data traffic;
one or more ports operatively coupled to the one or more data lanes, wherein the one or more ports are aggregated using an aggregated switching model; and
a unitary interface operatively coupled to the one or more ports and adapted for external connection.

2. The aggregated port of claim 1, wherein the aggregated switching model defines an aggregation topology associated with the aggregation of the one or more ports, wherein the aggregated switching model comprises logical parameters and physical parameters.

3. The aggregated port of claim 1, wherein the aggregated port is operatively coupled to a first device via the unitary interface.

4. The aggregated port of claim 3, wherein, when the aggregated port is operatively coupled to the first device, only the unitary interface is visible to a user, and the one or more ports and the one or more data lanes are obscured from the user.

5. The aggregated port of claim 3, wherein the first device is a host device.

6. The aggregated port of claim 1, wherein the one or more ports are operatively coupled to one or more data lanes such that each port is operatively coupled to a corresponding data lane.

7. The aggregated port of claim 1, wherein the one or more ports are operatively coupled to one or more data lanes such that each port is operatively coupled to two or more data lanes.

8. The aggregated port of claim 1, wherein the one or more ports operate independently of one another.

9. A system for aggregating ports in a centralized software defined network (SDN) environment, comprising:
a first device; and
a port aggregation module operatively coupled to the first device, wherein the port aggregation module is to:
receive data transfer requirements associated with data communication to a second device;
generate an aggregated switching model based on at least the data transfer requirements; and
configure, using an SDN controller, an aggregated port to facilitate the transfer of data to the second device based on the aggregated switching model.

10. The system of claim 9, wherein the aggregated switching model defines an aggregation topology associated with the configuring of the aggregated port, wherein the aggregated switching model comprises logical parameters and physical parameters.

11. The system of claim 9, wherein the aggregated port further comprises:
one or more data lanes adapted to handle data traffic;
one or more ports operatively coupled to the one or more data lanes, wherein the one or more ports are aggregated using an aggregated switching model; and
a unitary interface operatively coupled to the one or more ports and adapted for external connection.

12. The system of claim 11, wherein, when the aggregated port is operatively coupled to the first device, only the unitary interface is visible to a user, and the one or more ports and the one or more data lanes are obscured from the user.

13. The system of claim 9, wherein the first device is a host device.

14. The system of claim 9, wherein the one or more data transfer requirements comprises at least a bandwidth requirement.

15. A method for aggregating ports in a centralized software defined network (SDN) environment, the method comprising:
receiving data transfer requirements associated with data communication to a second device;
generating an aggregated switching model based on at least the data transfer requirements; and
configuring, using an SDN controller, an aggregated port to facilitate the transfer of data to the second device based on the aggregated switching model.

16. The method of claim 15, wherein the aggregated switching model defines an aggregation topology associated with the configuring of the aggregated port, wherein the aggregated switching model comprises logical parameters and physical parameters.

17. The method of claim 15, wherein the aggregated port further comprises:
one or more data lanes adapted to handle data traffic;
one or more ports operatively coupled to the one or more data lanes, wherein the one or more ports are aggregated using an aggregated switching model; and
a unitary interface operatively coupled to the one or more ports and adapted for external connection.

18. The method of claim 17, wherein the aggregated port is operatively coupled to a first device via the unitary interface.

19. The method of claim 18, wherein, when the aggregated port is operatively coupled to the first device, only the unitary interface is visible to a user, and the one or more ports and the one or more data lanes are obscured from the user.

20. The method of claim 15, wherein the one or more data transfer requirements comprises at least a bandwidth requirement.
